(19) United States
(12) Patent Application Publication
(10) Pub. No.: US 2016/0078035 A1
(43) Pub. Date: Mar. 17, 2016

(54) SYSTEMS AND METHODS FOR PROVIDING REAL-TIME CONTENT ITEMS ASSOCIATED WITH TOPICS

(71) Applicant: Facebook, Inc., Menlo Park, CA (US)

(72) Inventors: Allison Elaine Ball, Austin, TX (US); Jeremy Robert Cohen, New York, NY (US); Sadi Sufi Khan, Mountain View, CA (US)

(21) Appl. No.: 14/483,867

(22) Filed: Sep. 11, 2014

(51) Int. Cl. G06F 17/30; H04L 29/12

(52) U.S. Cl. CPC G06F 17/3053; G06F 17/30554; H04L 61/609

(57) ABSTRACT

Systems, methods, and non-transitory computer-readable media can acquire a topic for which associated content is to be provided. A set of content items that are associated with the topic can be identified. The set of content items can be ranked based, at least in part, on time data associated with the set of content items. A subset of content items can be selected out of the set of content items. In some instances, the subset of content items can be selected to include an amount of highest ranked content items. The subset of content items can be provided in real-time.

### FIELD OF THE INVENTION

The present technology relates to the field of providing content. More particularly, the present technology relates to techniques for providing real-time content items associated with topics.

### BACKGROUND

Today, people often utilize computing devices (or systems) for a wide variety of purposes. Users can use their computing devices, for example, to interact with one another, access content, share content, and create content. In some cases, a user of a social networking system (or service) can utilize his or her computing device to provide, post, share, and access various content items, such as status updates and links to articles, via the social networking system.

Under conventional approaches, each piece of content is generally provided separately and independently. Moreover, in accordance with conventional approaches, content items posted and presented at a user's profile, timeline, or newsfeed are generally unrelated to one another. Furthermore, in conventional approaches, content items on the user's profile, timeline, or newsfeed can be posted from a long time ago and become outdated or uninteresting. As such, conventional approaches can create challenges for or reduce the overall user experience associated with providing interesting content.

### SUMMARY

Various embodiments of the present disclosure can include systems, methods, and non-transitory computer readable media configured to acquire a topic for which associated content is to be provided. A set of content items that are associated with the topic can be identified. The set of content items can be ranked based, at least in part, on time data associated with the set of content items. A subset of content items can be selected out of the set of content items. In some instances, the subset of content items can be selected to include an amount of highest ranked content items. The subset of content items can be provided in real-time.

In an embodiment, the ranking of the set of content items based, at least in part, on the time data associated with the set of content items can further comprise analyzing the time data to determine when each respective content item in the set of content items was posted. In some cases, each respective content item in the set of content items can be posted within an allowable time frame. The set of content items can be ordered from most recently posted to least recently posted.

In an embodiment, the set of content items can be ranked based on a relevance score associated with each respective content item in the set of content items.

In an embodiment, the relevance score can indicate a level of social importance of the respective content item relative to one or more other content items in the set of content items.

In an embodiment, the relevance score can be determined based on at least one of a language associated with a viewing user accessing the respective content item, a reading-level associated with the viewing user, geolocation data associated with the viewing user, or information about a posting user who provided the respective content item.

In an embodiment, the identifying of the set of content items further comprises searching a social graph of a social networking system for content items that have a topic tag corresponding to the topic.

In an embodiment, an input element can be provided, for a viewing user who is accessing the subset of content items, to post a new content item in real-time.

In an embodiment, the providing of the subset of content items in real-time can include presenting the subset of content items in real-time to a first user. In some instances, the subset can include at least one private content item posted by a second user directly connected to the first user. In some cases, the at least one private content item can be prevented from being presented to at least a third user who is not directly connected to the second user.

In an embodiment, the subset of content items can be provided to a viewing user. In some instances, the topic can be determined in real-time based on at least one of an action performed by the viewing user or environmental data associated with the viewing user.

In an embodiment, the providing of the subset of content items in real-time can include displaying at least a portion of the subset of content items to a viewing user in real-time via a live ticker interface.

In an embodiment, the live ticker interface can be displayed within a content display page accessed by the viewing user. In some instances, the live ticker interface can correspond to a section that is stationary in display position relative to one or more other sections within the content display page.

In an embodiment, the content display page can be associated with at least one of a social networking page, a timeline, a profile, or a newsfeed.

In an embodiment, the subset of content items can include at least a first content item and a second content item. In some cases, the first content item can be provided at a first display position in the live ticker interface and the second content item can be provided at a second display position in the live ticker interface. In some instances, the second content item can be posted at a more recent time than the first content item. In some cases, the first display position can be moved vertically lower, relative to the second display position, when the second content item is provided at the second display position.

In an embodiment, the live ticker interface can be scrollable within the section that is stationary. In some instances, the content display page can be scrollable.

In an embodiment, a scroll action performed by the viewing user to scroll through the live ticker interface can be detected. Movement of the first display position and the second display position can be prevented when a third content item included in the subset is provided at a third display position in the live ticker interface.

In an embodiment, a posting user can be identified for each respective content item in the subset of content items. Information about the posting user can be provided in association with the respective content item being provided.

In an embodiment, each respective content item in the set of content items can be associated with at least one of a status update, a share, a link, or a text post.

In an embodiment, the subset of content items can be provided at a social networking system. In some cases, at least one content item in the set of content items can be acquired from a third-party system different from the social networking system.

Many other features and embodiments of the invention will be apparent from the accompanying drawings and from the following detailed description.

### BRIEF DESCRIPTION OF THE DRAWINGS

FIG. 1 illustrates an example system including an example real-time content module configured to facilitate providing real-time content items associated with topics, according to an embodiment of the present disclosure.

FIG. 2 illustrates an example content ranking module configured to facilitate providing real-time content items associated with topics, according to an embodiment of the present disclosure.

FIG. 3 illustrates an example content providing module configured to facilitate providing real-time content items associated with topics, according to an embodiment of the present disclosure.

FIG. 4 illustrates an example screenshot associated with providing real-time content items associated with topics, according to an embodiment of the present disclosure.

FIG. 5 illustrates an example screenshot associated with providing real-time content items associated with topics, according to an embodiment of the present disclosure.

FIG. 6 illustrates an example screenshot associated with providing real-time content items associated with topics, according to an embodiment of the present disclosure.

FIG. 7 illustrates an example method associated with providing real-time content items associated with topics, according to an embodiment of the present disclosure.

FIG. 8 illustrates an example method associated with providing real-time content items associated with topics, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Providing Real-Time Content Items Associated with Topics

People use social networking systems (or services) for various purposes. Users of a social networking system can utilize their computing devices (or systems) to establish connections, communicate, and interact with one another via the social networking system. Users can also provide, edit, share, or access content items such as text, notes, status updates, links, pictures, videos, and audio. In one example, a user of the social networking service can post or publish a content item, which can be presented on a profile page, such as on the user's timeline or on another user's timeline. In another example, the content item can be presented through a feed, such as a newsfeed, for the user or for another user to view and access. In some cases, the content item can, for example, be associated with at least one of a status update, a share, a link, a text post, and/or any combination thereof.

Conventional approaches generally involve content items being provided and presented separately and independently. Moreover, under conventional approaches, content items posted and presented at a particular profile page, timeline page, and/or newsfeed page are generally unrelated to one another. For example, one content item posted on a user's profile page can relate to a particular topic while another content item posted on the user's profile page can relate to a totally different topic. Furthermore, under conventional approaches, content items at a particular profile page, timeline page, and/or newsfeed page can be posted from a long time ago. These content items can become outdated, uninteresting, or irrelevant. Accordingly, conventional approaches can create challenges for and reduce the overall user experience associated with providing interesting content.

Therefore, an improved approach to providing content can be beneficial for addressing or alleviating various concerns associated with conventional approaches. Various embodiments of the present disclosure can provide in real-time (or near real-time, time within a predetermined threshold of real-time, time offset from real-time by a latency measure that is not observable to a user, etc.) content items associated with topics. In some embodiments, the disclosed technology can acquire a topic for which associated content is to be provided. A set of content items that are associated with the topic can be identified. The set of content items can be ranked based, at least in part, on time data associated with the set of content items. A subset of content items can be selected out of the set of content items. In some instances, the subset of content items can be selected to include an amount of highest ranked content items. The subset of content items can be provided in real-time.

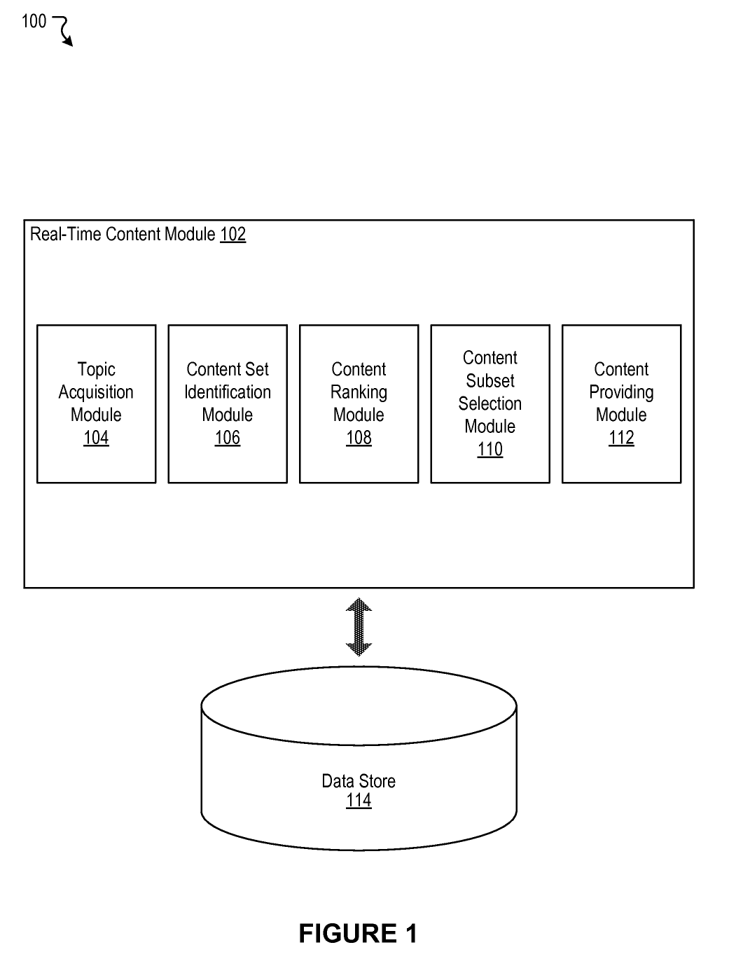

FIG. 1 illustrates an example system 100 including an example real-time content module 102 configured to facilitate providing real-time content items associated with topics, according to an embodiment of the present disclosure. As shown in FIG. 1, the example real-time content module 102 can include a topic acquisition module 104, a content set identification module 106, a content ranking module 108, a content subset selection module 110, and a content providing module 112. The example system 100 can also include at least one data store 114.

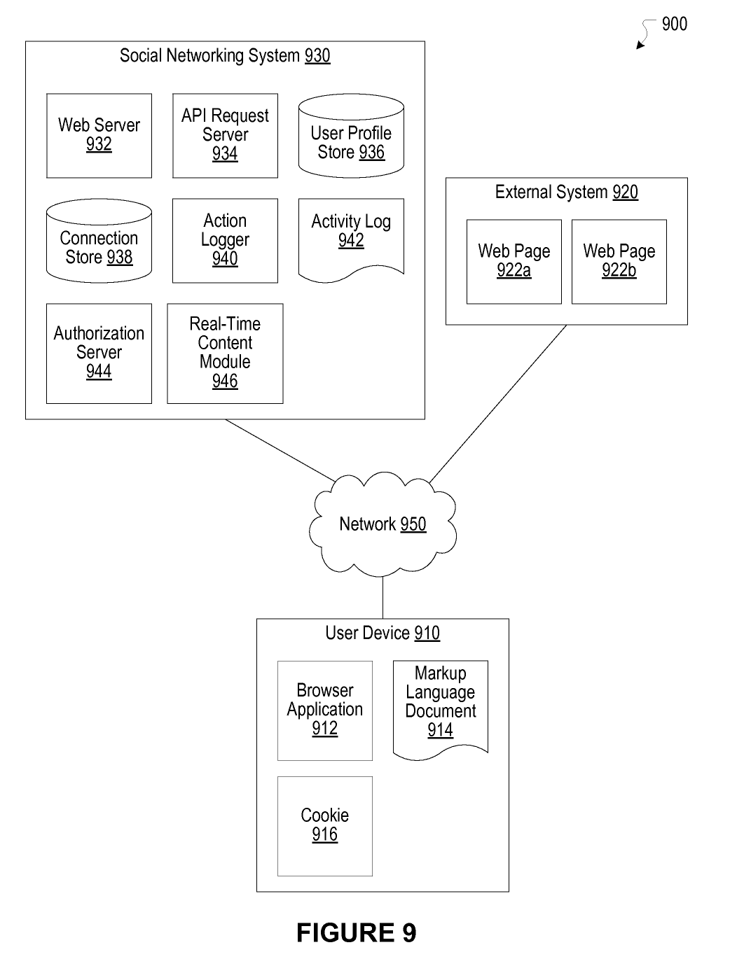

The at least one data store 114 can be configured to store and maintain various types of data. In some implementations, the at least one data store 114 can store information associated with a social networking system (or service), such as the social networking system 930 of FIG. 9. The information associated with the social networking system can include data about users, social connections, social interactions, locations, maps, places, events, groups, posts, communications, media, content, account settings, privacy settings, and various other types of data. As shown in the example system 100, the real-time content module 102 can be configured to operate with the at least one data store 114.

The topic acquisition module 104 can be configured to facilitate acquiring a topic for which associated content is to be provided. In some embodiments, a topic that is trending or popular within the social networking system can be acquired. For example, during a major sporting event, a trending topic can correspond to a celebrity athlete and the associated content can correspond to content about or otherwise related to the celebrity athlete. The topic corresponding to the celebrity athlete can be selected, received, or otherwise acquired by the topic acquisition module 104 during the major sporting event. In another example, a trending topic can correspond to a national or international event of significance. The topic corresponding to the national or international event can be selected, received, or otherwise acquired by the topic acquisition module 104 as a topic for which associated content is to be provided.

In some embodiments, a topic associated with a subject of a page within the social networking system can be acquired as a topic for which associated content is to be provided. For example, there can be many pages within the social networking system, one of which can be an official page for a particular entity (e.g., organization, public figure, interest, activity, etc.). The topic acquisition module 104 can acquire or select the topic corresponding to the particular entity as a topic for which associated content is to be provided.

Furthermore, at least some content associated with the topic is to be provided to a viewing user. In some implementations, the topic acquisition module 104 can acquire (e.g., determine, select, receive, etc.) the topic in real-time based on an action performed by the viewing user. For example, if the viewing user likes, shares, and/or comments on a post involving a particular topic, then the topic acquisition module 104 can acquire the particular topic as a topic for which associated content is to be provided. In another example, the viewing user can input one or more keywords for a search. The one or more keywords can specify a topic that is acquired or selected by the topic acquisition module 104.

In some implementations, the topic can be acquired or determined in real-time by the topic acquisition module 104 based on environmental data associated with the viewing user. In one example, if the viewing user has provided access to his or her computing device's microphone, then the topic acquisition module 104 can utilize audio data from the microphone and determine that a particular movie or television show is playing in the viewing user's environment. The topic acquisition module 104 can then acquire or choose a topic relating to the particular movie or television show. In another example, if the viewing user has provided access to his or her computing device's geolocation sensor(s), then the topic acquisition module 104 can utilize geolocation data to determine a current geolocation of the viewing user. The topic acquisition module 104 can then acquire or choose a topic relating to the current geolocation of the viewing user. It should be appreciated that many variations are possible.

The content set identification module 106 can be configured to facilitate identifying a set of content items that are associated with the topic. In some implementations, various content items can be tagged, labeled, and/or categorized, etc., as being associated with one or more topics. In one example, text analysis can be applied to a textual content item, such as a status update, a note, a comment, and/or an article, etc., in order to identify a topic tag for the textual content item. In another example, image analysis can be applied to an image content item, such as a picture, a photograph, and/or a video frame, etc., in order to identify a topic tag for the image content item. Various content items and their respective topic tags can be stored in the at least one data store 114. In some instances, the content items can be stored within a social graph of the social networking system, which can be maintained in the at least one data store 114.

In some embodiments, the content set identification module 106 can identify the set of content items based on searching the social graph of the social networking system for content items that have a topic tag corresponding to the topic. For example, if the acquired topic corresponds to a particular public figure, then the content set identification module 106 can identify the set to include all content items that have a topic tag corresponding to the particular public figure.

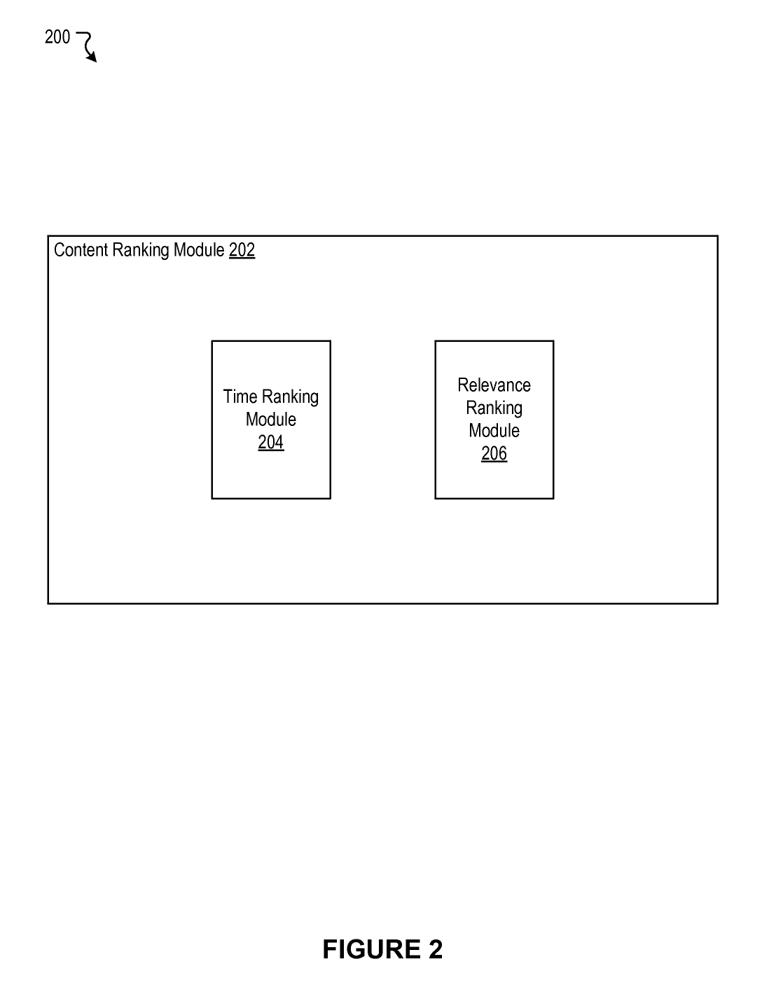

The content ranking module 108 can be configured to facilitate ranking the set of content items based, at least in part, on time data associated with the set of content items. The content ranking module 108 will be discussed in more detail below with reference to FIG. 2.

The content subset selection module 110 can be configured to facilitate selecting a subset of content items out of the set of content items. In some instances, the subset of content items can be selected to include an amount of highest ranked content items. For example, in some implementations, it can be specified that only the ten highest ranked content items can be selected to be included in the subset of content items. Many variations are possible.

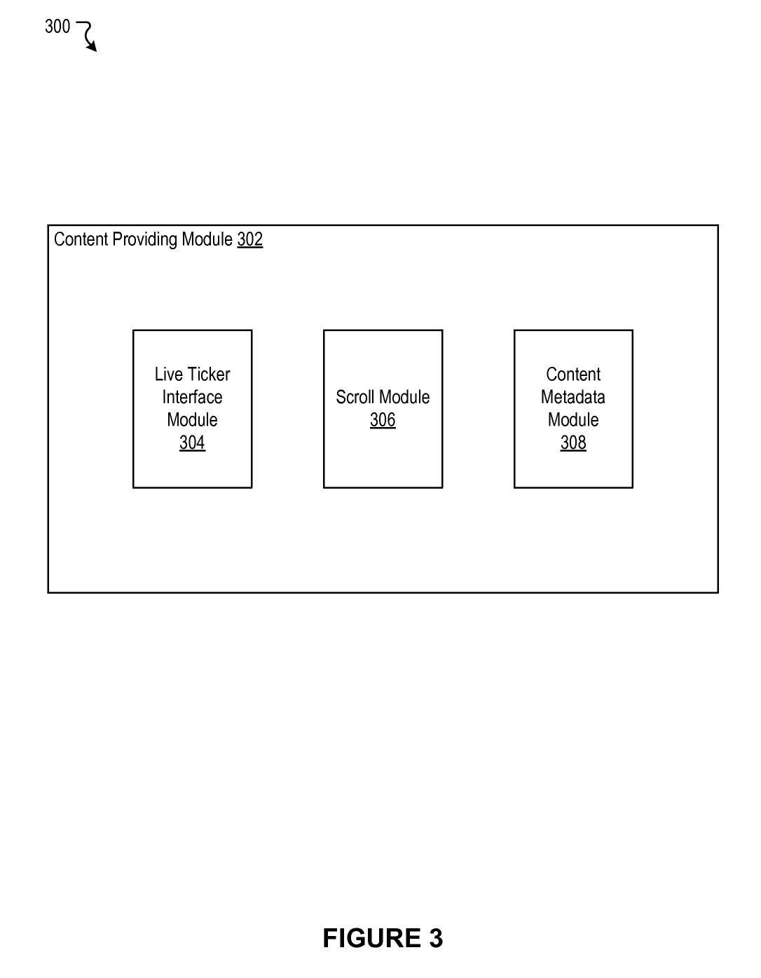

The content providing module 112 can be configured to facilitate providing the subset of content items in real-time. For example, the content providing module 112 can provide (e.g., present, display, etc.) at least a portion of the subset of content items to a viewing user in real-time (or near real-time). A more detailed discussion pertaining to the content providing module 112 will be provided below with reference to FIG. 3.

FIG. 2 illustrates an example content ranking module 202 configured to facilitate providing real-time content items associated with topics, according to an embodiment of the present disclosure. In some embodiments, the content ranking module 108 of FIG. 1 can be implemented as the example content ranking module 202. As shown, the example content ranking module 202 can include a time ranking module 204 and a relevance ranking module 206.

As discussed previously, the set of content items can be ranked based, at least in part, on time data associated with the set of content items. The time ranking module 204 can be configured to perform various tasks and/or operations associated with ranking the set of content items based, at least in part, on the time data associated with the set of content items.

In some implementations, the time ranking module 204 can facilitate the ranking of the set of content items based on the time data by analyzing the time data to determine when each respective content item in the set of content items was posted. In some cases, the time ranking module 204 can ensure that each respective content item in the set of content items was posted within an allowable time frame (e.g., within the last 10 seconds). If a content item in the set was not posted within the allowable time frame, the time ranking module 204 can, for example, remove or filter out the content item from the set and/or give the content item a low ranking. Moreover, the time ranking module 204 can order the set of content items from most recently posted to least recently posted.

In one example, a first content item in the set can be associated with the acquired topic and the time ranking module 204 can determine that the first content item was posted one second ago. A second content item in the set can also be associated with the acquired topic and the time ranking module 204 can determine that the second content item was posted two seconds ago. Further, the allowable time frame can correspond to the last ten seconds or the most recent ten seconds. In some embodiments, the time ranking module 204 can rank the first content item higher than the second content item because the first content item was posted at a more recent time than was the second content item.

In another example, the time ranking module 204 can determine that a third content item was posted one second ago, that a fourth content item was posted two seconds ago, and that a fifth content item was posted 15 seconds ago. In this example, the allowable time frame can correspond to the last ten seconds. In some embodiments, the time ranking module 204 can give the same (or substantially similar) rankings to the third and fourth content items, but a lower ranking to the fifth content item because the fifth content item was not posted within the allowable time frame. In some embodiments, the time ranking module 204 can remove or filter out the fifth content item out of the identified set of content items.

Moreover, the relevance ranking module 206 can be configured to facilitate ranking the set of content items based on a relevance score associated with each respective content item in the set of content items. The relevance ranking module 206 can determine or calculate a relevance score for each respective content item in the set. In some instances, the relevance score can indicate a level of social importance of the respective content item relative to one or more other content items in the set of content items. For example, the relevance ranking module 206 can calculate the relevance score for a particular content item in the set based on how many likes, up-votes, shares, comments, dislikes, down-votes, hides, and/or other interactions, etc., are received by the particular content item in comparison to interactions received by other content items in the set. In some cases, the more positive interactions received by a content item, the higher the content item can be ranked. It also follows that the more negative interactions received by a content item, the lower the content item can be ranked.

Furthermore, in some embodiments, the relevance ranking module 206 can be configured to determine or calculate the relevance score based on at least one of a language associated with a viewing user accessing the respective content item, a reading-level associated with the viewing user, geolocation data associated with the viewing user, information about a posting user who provided the respective content item, and/or any combination thereof. For example, the relevance score for a content item can be higher if the content item is associated with a language that the viewing user uses. In another example, if the reading-level of the viewing user corresponds to a high-school reading level, then a first content item associated with a college reading-level and a second content item associated with an elementary school reading-level can have lower relevance scores. In another example, if the content item is associated with a particular geolocation in which the viewing user is located, then the content item can have a higher relevance score. In a further example, if the content item was posted by a verified entity, such as a verified public figure or celebrity, then the relevance score for the content item can be higher. It is understood that many variations are possible.

As set forth herein, content items can be ranked higher or ranked lower based on various ranking criteria and/or factors. For example, at least some of the ranking criteria and/or factors can be associated with time data and relevance. Time data can indicate how recent a content item was posted. Relevance can be relative to a particular viewing user and/or can correspond to objective relevance (e.g., indicating a level of social importance or significance). In some embodiments, a higher ranking can mean an attendant increase in the ranking of the content item from an initial (or default) ranking of the content item. Likewise, in some embodiments, a lower ranking for a content item can mean an attendant decrease in the ranking of the content item from an initial ranking of the content item.

Additionally, in some implementations, at least one content item can be ranked and/or filtered out of (e.g., removed from) the set of content items based on privacy settings. In one example, one or more content items are provided or presented in real-time to a first user. The one or more content items can include at least one private content item posted by a second user who is directly connected to, or a social network friend of, the first user. However, the at least one private content item can be prevented from being presented or provided to at least a third user who is not directly connected to, or not a social network friend of, the second user.

FIG. 3 illustrates an example content providing module 302 configured to facilitate providing real-time content items associated with topics, according to an embodiment of the present disclosure. In some embodiments, the content providing module 112 of FIG. 1 can be implemented as the example content providing module 302. As shown in FIG. 3, the example content providing module 302 can include a live ticker interface module 304, a scroll module 306, and a content metadata module 308.

As discussed above, a subset of content items including an amount of highest ranked content items can be selected out of a set of content items identified as being associated with a topic. The content providing module 302 can be configured to provide the subset of content items in real-time, such as to a viewing user. In some embodiments, the live ticker module 304 of the content providing module 302 can be configured to facilitate the providing of the subset of content items in real-time by displaying at least a portion of the subset of content items to the viewing user in real-time via a live ticker interface. The live ticker interface can be utilized to provide, present, and/or display one or more content items in the subset in real-time (or near real-time). In some instances, when a more recently posted content item is displayed in the live ticker interface, a less recently posted content item can be visually pushed downward in the interface. In some cases, content items that get pushed downward become not readily visible.

In one example, the subset of content items includes a first content item and a second content item. The live ticker interface module 304 can cause the first content item to be provided (e.g., presented, displayed, etc.) at a first display position in the live ticker interface and the second content item to be provided at a second display position in the live ticker interface. In this example, the second content item can be posted at a more recent time than the first content item. As such, when the second content item is provided at the second display position, the live ticker interface module 304 can cause the first display position, at which the first content item is displayed, to be moved vertically lower relative to the second display position.

In some embodiments, the live ticker interface module 304 can cause the live ticker interface to be displayed within a content display page accessed by a viewing user. The content display page can, for example, be associated with at least one of a social networking page, a timeline, a profile, a newsfeed, and/or any combination thereof. In some implementations, the live ticker interface can correspond to a section that is stationary in display position relative to one or more other sections within the content display page.

In some embodiments, the live ticker interface can be scrollable within the section that is stationary. Furthermore, in some cases, the content display page can be scrollable. For example, the content display page can be scrolled in order to navigate through various sections within the content display page. The scroll module 306 can be configured to detect a scroll action performed by the viewing user to scroll through the live ticker interface. Continuing with the previous example, in some implementations, subsequent to detecting the scroll action, the scroll module 306 can work in conjunction with the live ticker interface module 304 to prevent movement of the first display position and the second display position when a third content item included in the subset is provided at a third display position in the live ticker interface.

In addition, the content metadata module 308 can be configured to facilitate providing metadata for each respective content item in the subset of content items. Metadata for each respective content item can refer to information about the respective content item. In one example, the content metadata module 308 can identify a posting user for each respective content item in the subset of content items. The content metadata module 308 can provide information about the posting user in association with the respective content item being provided. It is contemplated that many variations are possible.

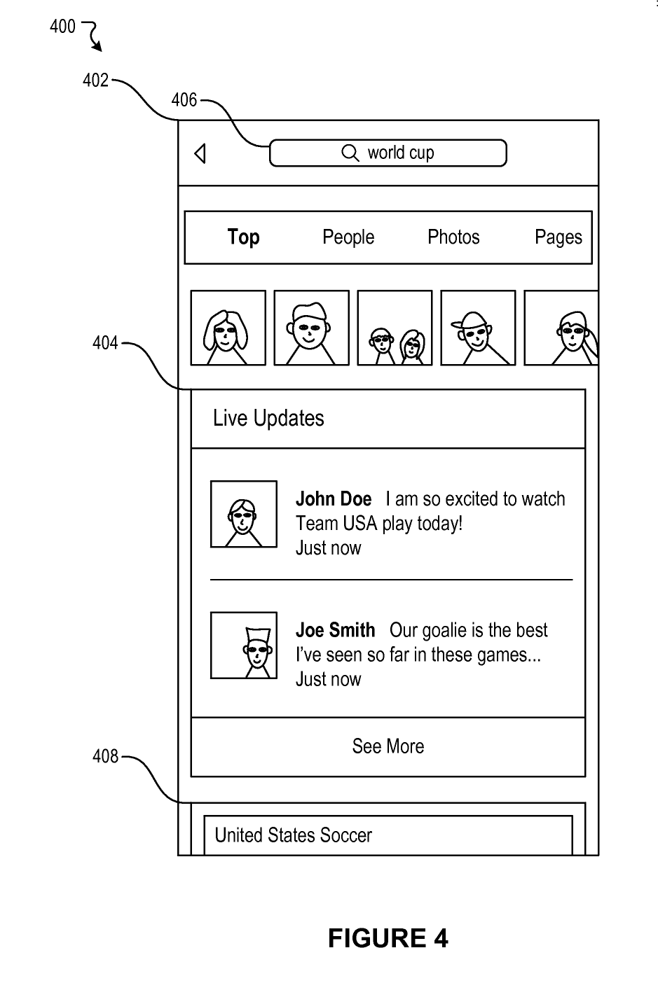

FIG. 4 illustrates an example screenshot 400 associated with providing real-time content items associated with topics, according to an embodiment of the present disclosure. The example screenshot 400 includes an example content display page 402, a live ticker interface 404, a search bar 406, and another content section 408.

As discussed, the content display page 402 can, for example, be associated with at least one of a social networking page, a timeline, a profile, a newsfeed, and/or any combination thereof. As shown in the example screenshot 400, the live ticker interface 404 can provide, present, and/or display at least a portion of a subset of highest ranked content items that are associated with an acquired topic. In this example, a more recently posted content item can be displayed above a less recently posted content item.

In some embodiments, the search bar 406 can be utilized to acquire the topic for which associated content is to be provided. As shown in the example, a viewing user can input “world cup” into the search bar 406, such that the acquired topic corresponds to the inputted “world cup” topic.

Moreover, the live ticker interface 404 can correspond to a section that is stationary in display position relative to one or more other sections 408 within the content display page 402. In some instances, the live ticker interface 404 can be scrollable within the section that is stationary. For example, the viewing user can scroll through the content items displayed in the live ticker interface 404, while the live ticker interface 404 remains stationary relative to the content display page 402. Furthermore, in some cases, the content display page 402 can be scrollable. For example, the content display page 402 can be scrolled in order to navigate through various sections within the content display page 402, such as the live ticker interface 404 and the other content section 408.

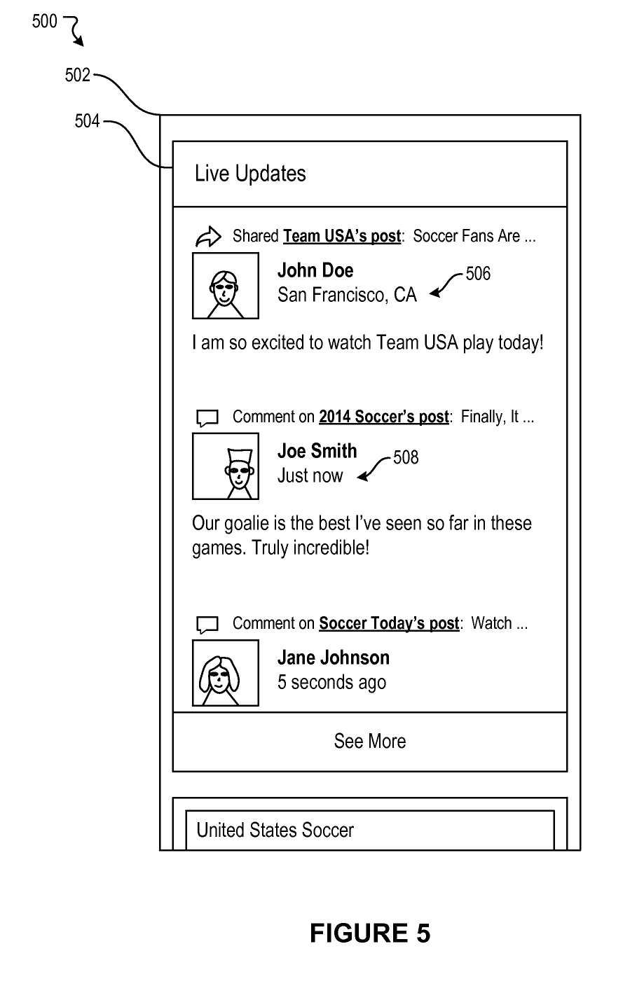

FIG. 5 illustrates an example screenshot 500 associated with providing real-time content items associated with topics, according to an embodiment of the present disclosure. The example screenshot 500 can include a content display page 502 and a live ticker interface 504 within the content display page 502.

In some embodiments, metadata for content items, or information associated with the content items, can be provided in conjunction with the content items. In one example, locational information 506 about a posting user of a first content item can be provided with the first content item. In another example, time information 508 indicating when a second content item was posted can also be provided with the second content item. It is understood that many variations are possible.

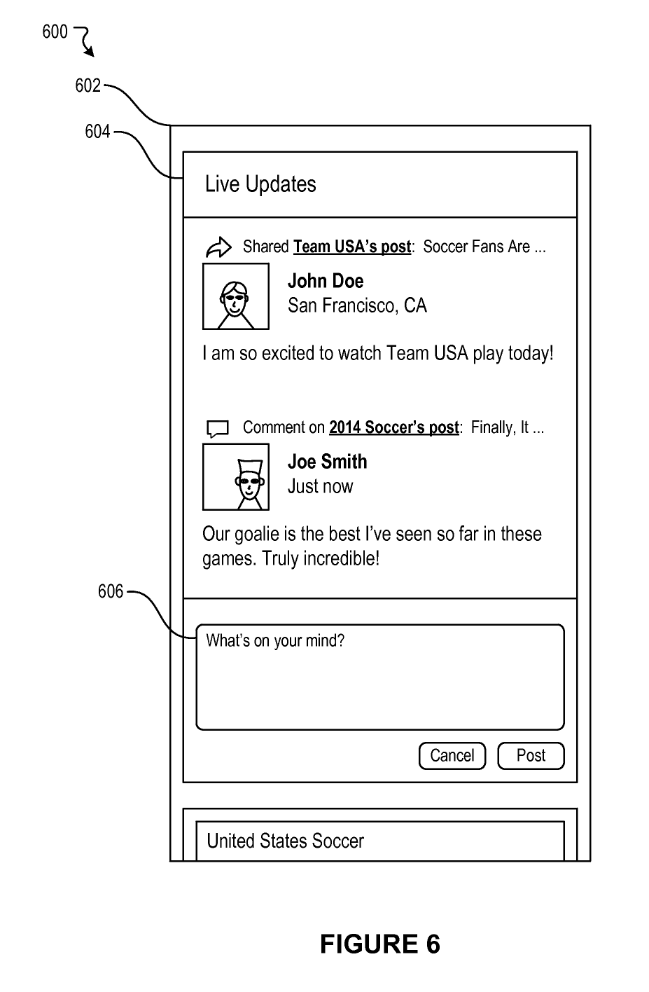

FIG. 6 illustrates an example screenshot 600 associated with providing real-time content items associated with topics, according to an embodiment of the present disclosure. The example screenshot 600 can include a content display page 602 and a live ticker interface 604 within the content display page 602.

In some embodiments, an input element 606 can be provided for a viewing user who is accessing the subset of content items. The input element 606 can be provided for the viewing user to post a new content item in real-time.

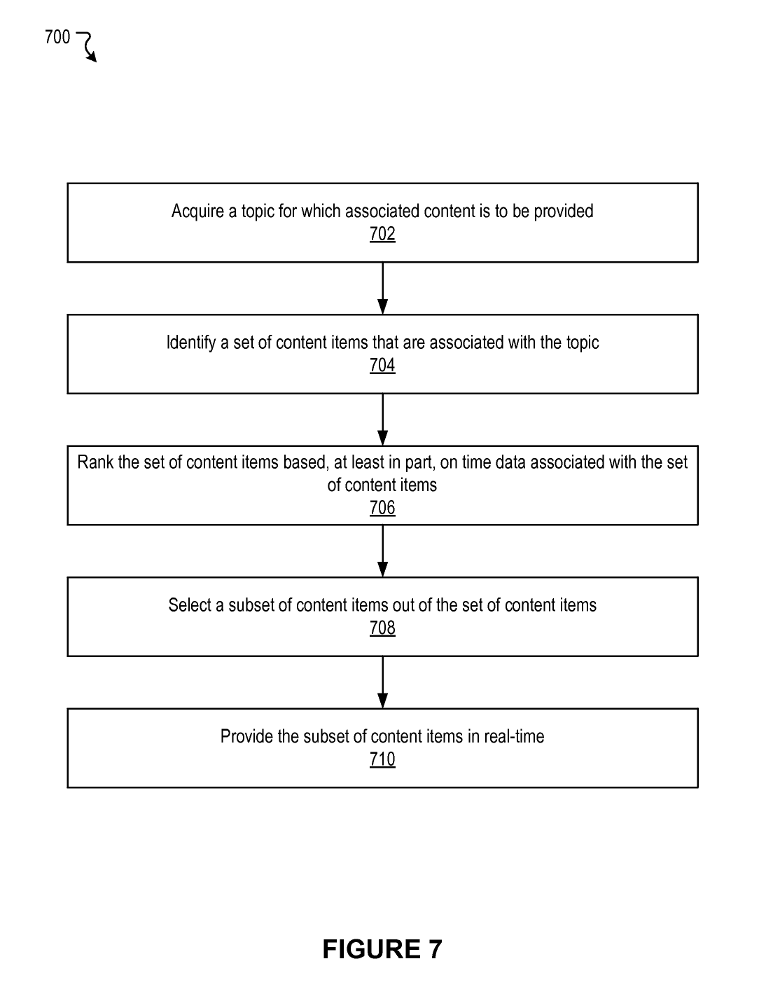

FIG. 7 illustrates an example method 700 associated with providing real-time content items associated with topics, according to an embodiment of the present disclosure. It should be appreciated that there can be additional, fewer, or alternative steps performed in similar or alternative orders, or in parallel, within the scope of the various embodiments unless otherwise stated.

At block 702, the example method 700 can acquire a topic for which associated content is to be provided. At block 704, the example method 700 can identify a set of content items that are associated with the topic. For example, the identifying of the set of content items can further comprise searching a social graph of a social networking system for content items that have a topic tag corresponding to the topic.

At block 706, the example method 700 can rank the set of content items based, at least in part, on time data associated with the set of content items. At block 708, the example method 700 can select a subset of content items out of the set of content items. In some implementations, the subset of content items can be selected to include an amount of highest ranked content items.

At block 710, the example method 700 can provide the subset of content items in real-time. In some embodiments, the subset of content items can be provided to one or more viewing users via a live ticker interface.

In some embodiments, the subset of content items can be provided at a social networking system. In some cases, at least one content item in the set of content items can be acquired from a third-party system different from the social networking system.

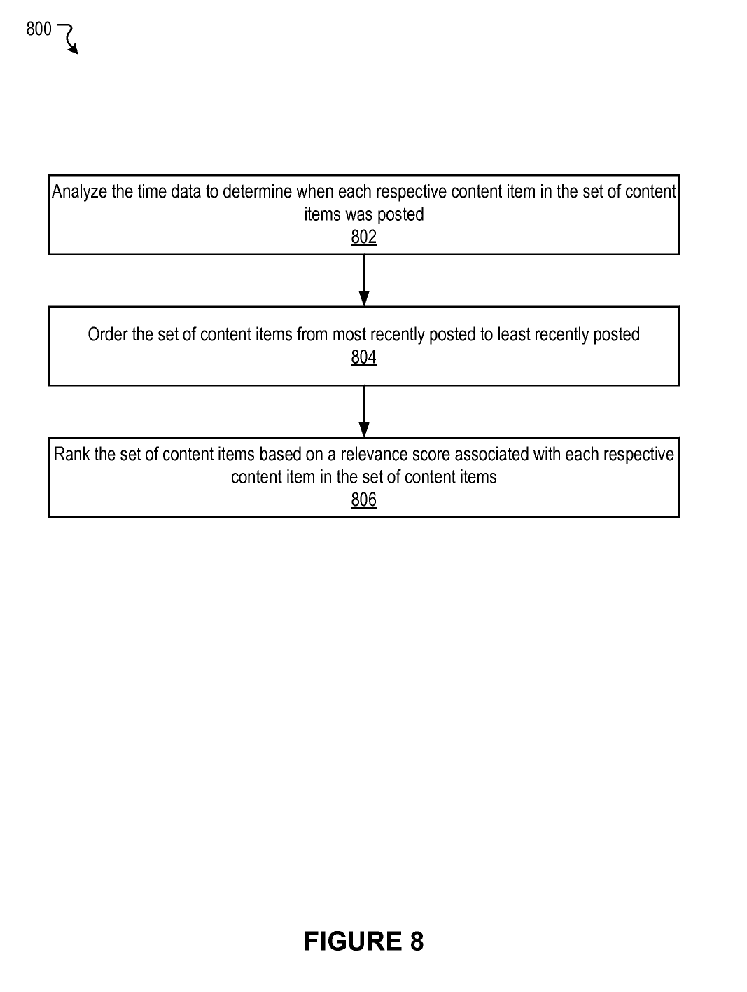

FIG. 8 illustrates an example method 800 associated with providing real-time content items associated with topics, according to an embodiment of the present disclosure. Again, it should be appreciated that there can be additional, fewer, or alternative steps performed in similar or alternative orders, or in parallel, within the scope of the various embodiments unless otherwise stated.

At block 802, the example method 800 can analyze the time data to determine when each respective content item in the set of content items was posted. In some cases, each respective content item in the set of content items can be posted within an allowable time frame, such as within the most recent ten seconds. At block 804, the example method 800 can order the set of content items from most recently posted to least recently posted.

At block 806, the example method 800 can rank the set of content items based on a relevance score associated with each respective content item in the set of content items. In some implementations, the relevance score can indicate a level of social importance of the respective content item relative to one or more other content items in the set of content items. In some cases, the relevance score can be determined based on a language associated with a viewing user accessing the respective content item, a reading-level associated with the viewing user, geolocation data associated with the viewing user, and/or information about a posting user who provided the respective content item.

Again, it is contemplated that there can be many other uses, applications, and/or variations associated with the various embodiments of the present disclosure. For example, various embodiments of the present disclosure can learn, improve, and/or be refined over time.

### Social Networking System—Example Implementation

FIG. 9 illustrates a network diagram of an example system 900 that can be utilized in various scenarios, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920. In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the social networking system 930 can include a real-time content module 946. The real-time content module 946 can, for example, be implemented as the real-time content module 102 of FIG. 1. The real-time content module 946 can be configured to facilitate acquiring a topic for which associated content is to be provided. The real-time content module 946 can be configured to facilitate identifying a set of content items that are associated with the topic. The real-time content module 946 can also be configured to facilitate ranking the set of content items based, at least in part, on time data associated with the set of content items. The real-time content module 946 can further be configured to facilitate selecting a subset of content items out of the set of content items. In some instances, the subset of content items can be selected to include an amount of highest ranked content items. Moreover, the real-time content module 946 can be configured to facilitate providing the subset of content items in real-time. It is understood that many variations are possible.

### Hardware Implementation

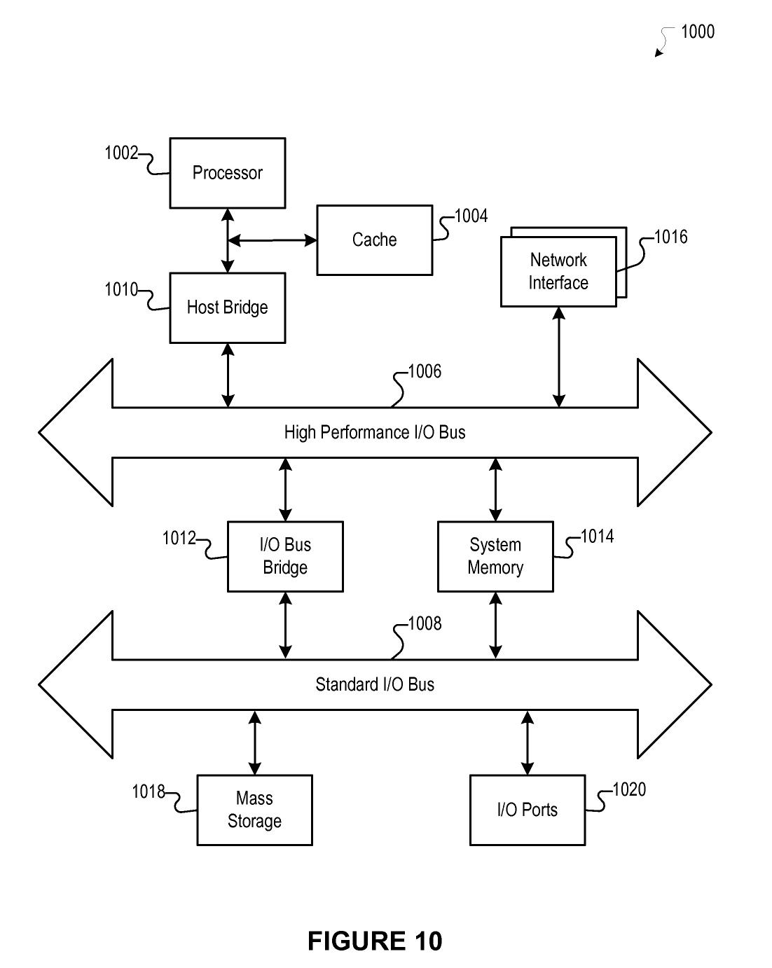

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 930, the user device 910, and the external system 1020, or a component thereof. In an embodiment of the invention, the computer system 1000 may be one server among many that constitutes all or part of the social networking system 930.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
acquiring, by a computing system, a topic for which associated content is to be provided;
identifying, by the computing system, a set of content items that are associated with the topic;
ranking, by the computing system, the set of content items based, at least in part, on time data associated with the set of content items;
selecting, by the computing system, a subset of content items out of the set of content items, the subset of content items being selected to include an amount of highest ranked content items; and
providing, by the computing system, the subset of content items in real-time.

2. The computer-implemented method of claim 1, wherein the ranking of the set of content items based, at least in part, on the time data associated with the set of content items further comprises:
analyzing the time data to determine when each respective content item in the set of content items was posted, wherein each respective content item in the set of content items was posted within an allowable time frame; and
ordering the set of content items from most recently posted to least recently posted.

3. The computer-implemented method of claim 1, further comprising:
ranking the set of content items based on a relevance score associated with each respective content item in the set of content items.

4. The computer-implemented method of claim 3, wherein the relevance score indicates a level of social importance of the respective content item relative to one or more other content items in the set of content items.

5. The computer-implemented method of claim 3, wherein the relevance score is determined based on at least one of a language associated with a viewing user accessing the respective content item, a reading-level associated with the viewing user, geolocation data associated with the viewing user, or information about a posting user who provided the respective content item.

6. The computer-implemented method of claim 1, wherein the identifying of the set of content items further comprises searching a social graph of a social networking system for content items that have a topic tag corresponding to the topic.

7. The computer-implemented method of claim 1, further comprising:
providing an input element, for a viewing user who is accessing the subset of content items, to post a new content item in real-time.

8. The computer-implemented method of claim 1, wherein the providing of the subset of content items in real-time includes presenting the subset of content items in real-time to a first user, wherein the subset includes at least one private content item posted by a second user directly connected to the first user, and wherein the at least one private content item is prevented from being presented to at least a third user who is not directly connected to the second user.

9. The computer-implemented method of claim 1, wherein the subset of content items is provided to a viewing user, and wherein the topic is determined in real-time based on at least one of an action performed by the viewing user or environmental data associated with the viewing user.

10. The computer-implemented method of claim 1, wherein the providing of the subset of content items in real-time includes displaying at least a portion of the subset of content items to a viewing user in real-time via a live ticker interface.

11. The computer-implemented method of claim 10, wherein the live ticker interface is displayed within a content display page accessed by the viewing user, and wherein the live ticker interface corresponds to a section that is stationary in display position relative to one or more other sections within the content display page.

12. The computer-implemented method of claim 11, wherein the content display page is associated with at least one of a social networking page, a timeline, a profile, or a newsfeed.

13. The computer-implemented method of claim 11, wherein the subset of content items includes at least a first content item and a second content item, wherein the first content item is provided at a first display position in the live ticker interface and the second content item is provided at a second display position in the live ticker interface, wherein the second content item was posted at a more recent time than the first content item, and wherein the first display position is moved vertically lower, relative to the second display position, when the second content item is provided at the second display position.

14. The computer-implemented method of claim 13, wherein the live ticker interface is scrollable within the section that is stationary, and wherein the content display page is scrollable.

15. The computer-implemented method of claim 14, further comprising:
detecting a scroll action performed by the viewing user to scroll through the live ticker interface; and
preventing movement of the first display position and the second display position when a third content item included in the subset is provided at a third display position in the live ticker interface.

16. The computer-implemented method of claim 1, further comprising:
identifying a posting user for each respective content item in the subset of content items; and
providing information about the posting user in association with the respective content item being provided.

17. The computer-implemented method of claim 1, wherein each respective content item in the set of content items is associated with at least one of a status update, a share, a link, or a text post.

18. The computer-implemented method of claim 1, wherein the subset of content items is provided at a social networking system, and wherein at least one content item in the set of content items is acquired from a third-party system different from the social networking system.

19. A system comprising:
at least one processor; and
a memory storing instructions that, when executed by the at least one processor, cause the system to perform:
acquiring a topic for which associated content is to be provided;
identifying a set of content items that are associated with the topic;
ranking the set of content items based, at least in part, on time data associated with the set of content items;
selecting a subset of content items out of the set of content items, the subset of content items being selected to include an amount of highest ranked content items; and
providing the subset of content items in real-time.

20. A non-transitory computer-readable storage medium including instructions that, when executed by at least one processor of a computing system, cause the computing system to perform:
acquiring a topic for which associated content is to be provided;
identifying a set of content items that are associated with the topic;
ranking the set of content items based, at least in part, on time data associated with the set of content items;
selecting a subset of content items out of the set of content items, the subset of content items being selected to include an amount of highest ranked content items; and
providing the subset of content items in real-time.
